(19) United States
(12) Patent Application Publication
(10) Pub. No.: US 2018/0364647 A1
(43) Pub. Date: Dec. 20, 2018

(54) DOG-FACED WATCH SYSTEM

(71) Applicant: Gary Gaeth, St. George, UT (US)

(72) Inventor: Gary Gaeth, St. George, UT (US)

(21) Appl. No.: 15/889,183

(22) Filed: Feb. 5, 2018

Related U.S. Application Data
(60) Provisional application No. 62/522,204, filed on Jun. 20, 2017.

(51) Int. Cl. G04B 47/00; G04B 19/10; A01K 27/00

(52) U.S. Cl. CPC G04B 47/00; G04G 9/00; A01K 27/006; G04B 19/10

(57) ABSTRACT

A dog-faced watch system including a collar including a watch having a face, a time display, and a powerer, a fastener, and a leash loop. The collar is configured to be removably secured to a neck of a canine via the fastener. The face of the watch displays a three-dimensional representation of a dog face. The watch provides time identification as desired and the collar allows a user to control a canine. The dog face may be a selected dog breed.

### CROSS REFERENCE TO RELATED APPLICATION

The present application is related to and claims priority to U.S. Provisional Patent Application No. 62/522,204 filed Jun. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of pet accessories and more specifically relates to a dog collar.

### 2. Description of Related Art

A dog collar is a piece of material put around the neck of a dog. A collar may be used for control, identification, fashion, or other purposes. Identification tags and medical information are often placed on dog collars. Collars are also useful for controlling a dog manually, as they provide a handle for grabbing. Collars are often used in conjunction with a leash while walking. Dog collars are often available in different colors and sizes; however, the collar typically lacks decoration. Pet owners may be bored and unhappy with the way their dog's collar looks. Further, owners may be unable to identify the time of day while taking their dog on a walk. A suitable solution is desired.

U.S. Pat. No. 6,502,060 to Lutrell M. Christian relates to a pet chronometer and identification tag. The described pet chronometer and identification tag includes a clock for the attachment of a dog's collar or the like that indicates the passage of time according to the dog's or pet's frame of reference. For example, the rate of passage of time may be such that for each human day of time passage, seven dog or pet days are reflected by the clocks display. Additional data, displays, and information may be carried, manipulated, entered and chosen by the use of user control buttons or the like. A battery may supply power to internal circuitry that drives a display of liquid crystals (LCD). The data carried by the pet chronometer and identification tag may be held in EEPROM such that a power failure does not erase the data. This is particularly useful for any health data or contact information that is incorporated or recorded into the pet chronometer and identification tag.

### BRIEF SUMMARY OF THE INVENTION

In view of the foregoing disadvantages inherent in the known pet accessories art, the present disclosure provides a novel dog-faced watch system. The general purpose of the present disclosure, which will be described subsequently in greater detail, is to provide a collar having a functional watch and 3-D representation of a dog face to provide ready identification means.

A dog-faced watch system is disclosed herein. The dog-faced watch system includes a collar with a watch having a face, a time display, and a powerer, a fastener, and a leash loop. The collar is configured to be removeably secured to a neck of a canine via the fastener. The face of the watch displays a three-dimensional representation of a dog. The powerer provides power to the watch. The leash loop is configured to receive and secure a leash therein. The watch provides time identification as desired. The three-dimensional representation is a functional image of a dog face providing a user with a functional watch and collar combination.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dog-faced watch system, constructed and operative according to the teachings of the present disclosure.

FIG. 1 is a front perspective view of the dog-faced watch system during an ‘in-use’ condition, according to an embodiment of the disclosure.

FIG. 2 is a front perspective view of the dog-faced watch system of FIG. 1, according to an embodiment of the present disclosure.

FIG. 3 is a front perspective view of the dog-faced watch system of FIG. 1, according to an embodiment of the present disclosure.

FIG. 4 is a front perspective view of the dog-faced watch system of FIG. 1, according to an embodiment of the present disclosure.

FIG. 5 is a perspective view of the dog-faced watch system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet accessory and more particularly to a dog-faced watch system as used to improve the dog collar by providing a functional and useful dog collar and watch combination.

Generally, the present invention provides dog collars with a watch attachment adorned with a dog breed illustration on the watch face. It includes both digital and dial watch styles, enabling pet owners to customize the dog collar as desired. It features numerous dog collar patterns and sizes capable of fitting various dog breeds and sizes. This allows pet owners to illuminate the watch face via a push button light. The present invention offers a fun and entertaining dog collar attachment while enabling pet owners to identify the time of day while out on a walk. The device may include the name of the pet such that the pet can be readily identified.

Dog-faced watch system may be customized digital and dial-style watch faces capable of being installed on a dog collar. The adornment allows pet owners to customize and personalize their dog's collar. The watch face may be wind-up or battery-powered with push button illumination. Dog-faced watch system can be constructed using plastic, leather, and other suitable materials. The watch face can be illustrated with any breed of a dog face, each suited to accommodate all user needs and preferences.

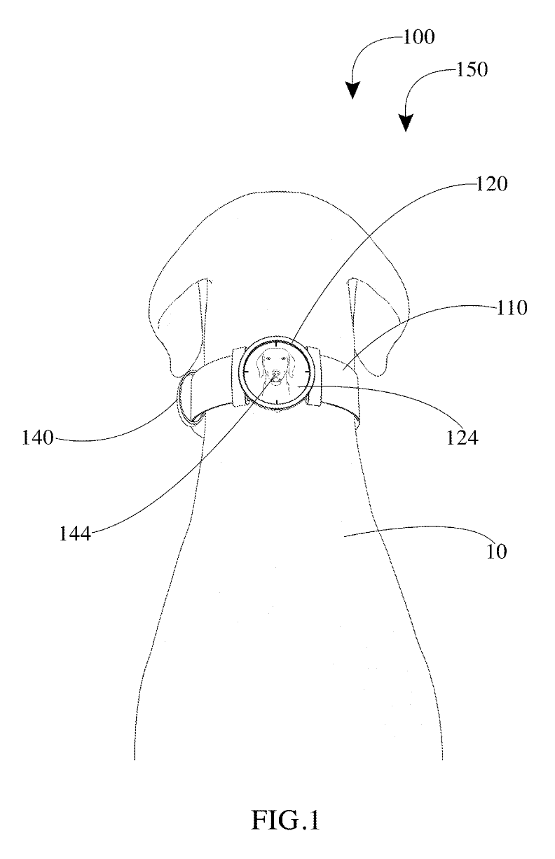

Referring now more specifically to the drawings by numerals of reference, there is shown in FIGS. 1-5, various views of a dog-faced watch system 100. FIG. 1 shows a dog-faced watch system 100 during an ‘in-use’ condition 150, according to an embodiment of the present disclosure. As illustrated, the dog-faced watch system 100 may include a collar 110 including a watch 120 having a face 124, a time display 128, and a powerer 132, a fastener 136, and a leash loop 140. The collar 110 is configured to be removeably secured to a neck of a canine 10 via the fastener 136. The face 124 of the watch 120 displays a three-dimensional representation 144 of a dog. The three-dimensional representation 144 is a functional image of a dog face. The powerer 132 provides power to the watch 120. The leash loop 140 is configured to receive and secure a leash therein. The watch 120 provides time identification as desired.

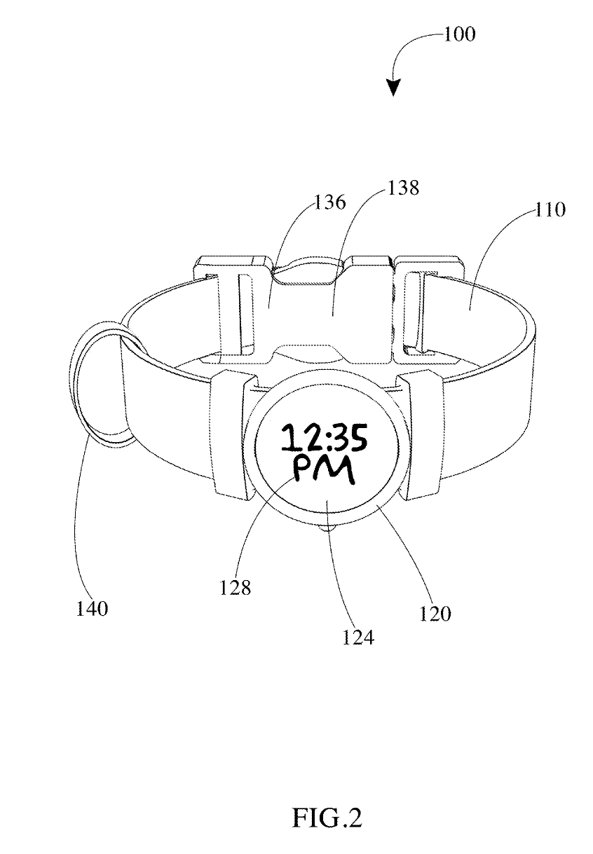

FIG. 2 shows a perspective view of the dog-faced watch system 100 of FIG. 1, according to an embodiment of the present disclosure. As above, the dog-faced watch system 100 may include the collar 110 having the watch 120, the fastener 136, and the leash loop 140. The face 124 of the watch 120 displays a three-dimensional representation 144 of a dog. The watch 120 face 124 can include different breeds of dogs illustrated on the face 124 of the watch 120. The watch 120 is integral to the collar 110 and is fastened to the collar 110 via sewing means. The collar 110 is flexible and configured to encircle the neck of the canine 10. The collar 110 may be used to control a canine 10 as needed and also provide ready access to time display 128.

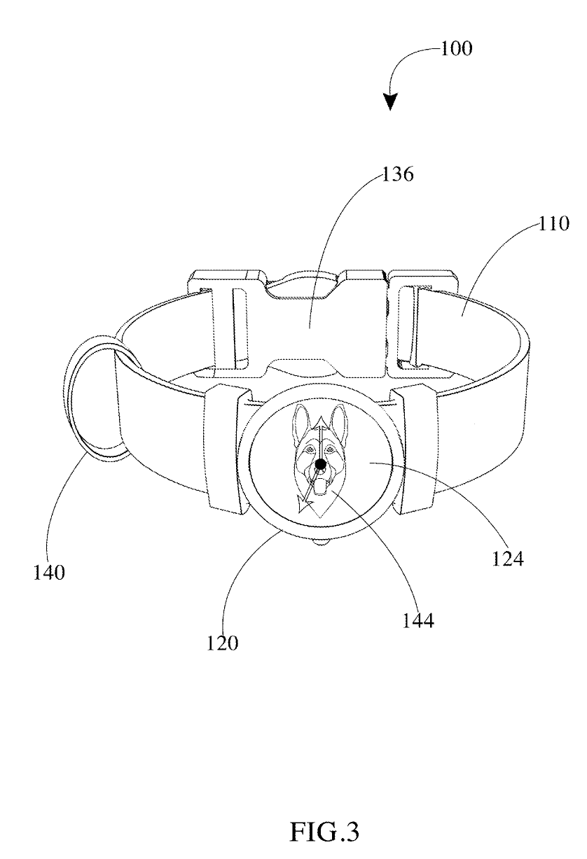

Referring now to FIG. 3 showing a perspective view of the dog-faced watch system 100 of FIG. 1, according to an embodiment of the present disclosure. As above, the dog-faced watch system 100 may include the collar 110 including the watch 120 having the face 124, the time display 128, and the powerer 132, the fastener 136, and the leash loop 140. The fastener 136 may include a buckle-fastener 138 or other suitable fastening means. The buckle-fastener 138 includes a male-portion and a female-portion configured to mate and secure the collar 110 in a circular configuration.

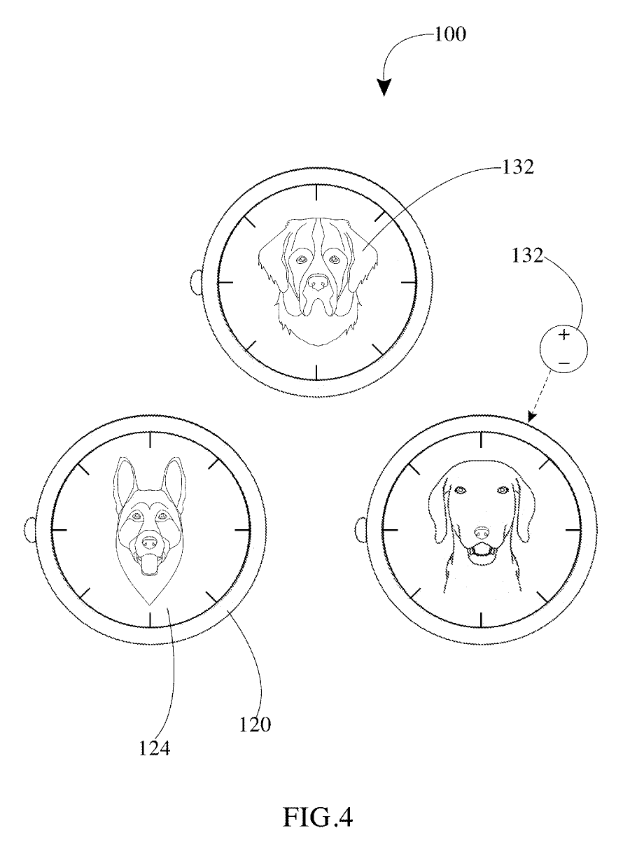

FIG. 4 shows a perspective view of the dog-faced watch system 100 of FIG. 1, according to an embodiment of the present disclosure. As above, the dog-faced watch system 100 may include the collar 110 having the watch 120, the fastener 136, and the leash loop 140. In certain embodiments, the watch 120 may include an illuminator. The illuminator is in communication with and powered via the powered 132. The watch 120 may include a push-button for activating the illuminator. The powerer 132 may include a battery, manual wind-up means, or other suitable power sources.

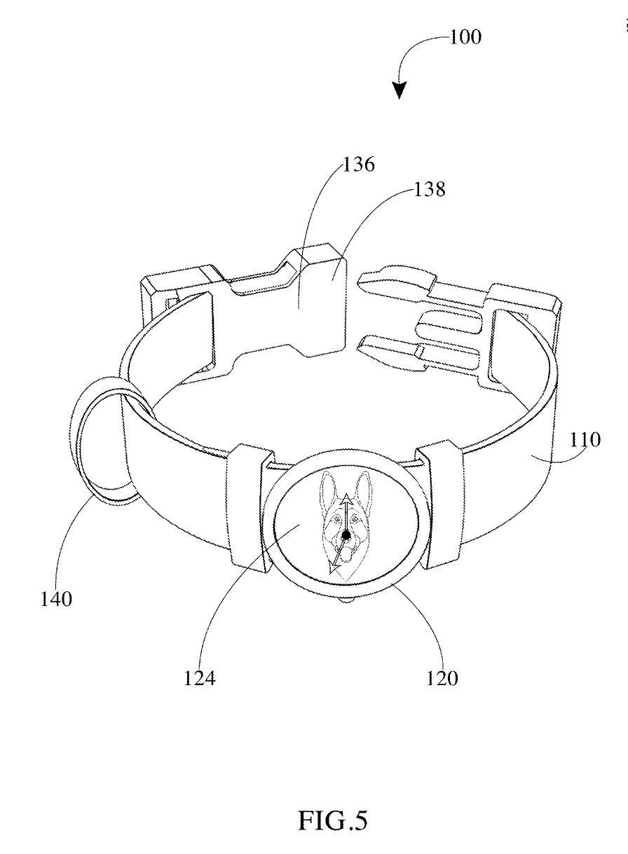

Referring now to FIG. 5 showing a perspective view of the dog-faced watch system 100 of FIG. 1, according to an embodiment of the present disclosure. As above, the dog-faced watch system 100 may include the watch 120. The watch 120 may be an analog watch or a digital watch. On the embodiment including an analog watch, the three-dimensional representation 144 of a dog is displayed on the face 120 of the watch 110 at all times. In the embodiment including the digital watch, the three-dimensional representation 144 of a dog may be displayed until a button is pressed to display the time display 128. The button controls the time display 128. The three-dimensional representation 144 of a dog is displayed when the button is not pressed.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dog-faced watch system comprising:
a collar including;
a watch having;
a face;
a time display; and
a powerer;
a fastener; and
a leash loop;
wherein said collar is configured to be removeably secured to a neck of a canine via said fastener;
wherein said face of said watch displays a three-dimensional representation of a dog;
wherein said powerer provides power to said watch;
wherein said leash loop is configured to receive and secure a leash therein; and
wherein said watch provides time identification as desired.

2. The dog-faced watch system of claim 1, wherein said three-dimensional representation is a functional image of a dog face.

3. The dog-faced watch system of claim 1, wherein said dog face is a selected breed of said dog.

4. The dog-faced watch system of claim 1, wherein said watch is fastened to said collar via sewing means.

5. The dog-faced watch system of claim 4, wherein said watch is integral to said collar.

6. The dog-faced watch system of claim 1, wherein said fastener comprises a buckle-fastener.

7. The dog-faced watch system of claim 6, wherein said buckle-fastener includes a male-portion and a female-portion configured to mate and secure said collar in a circular configuration.

8. The dog-faced watch system of claim 1, wherein said watch comprises an illuminator.

9. The dog-faced watch system of claim 1, wherein said illuminator is in communication with and powered via said powerer.

10. The dog-faced watch system of claim 1, wherein said powerer is a battery.

11. The dog-faced watch system of claim 1, wherein said powerer includes manual wind-up means.

12. The dog-faced watch system of claim 1, wherein said collar is flexible and configured to encircle said neck of said canine.

13. The dog-faced watch system of claim 1, wherein said watch is an analog said watch.

14. The dog-faced watch system of claim 1, wherein said watch digital said watch.

15. The dog-faced watch system of claim 14, wherein said digital said watch comprises a button.

16. The dog-faced watch system of claim 15, wherein said button controls said time display.

17. The dog-faced watch system of claim 16, wherein said time display is shown when said button is pressed.

18. The dog-faced watch system of claim 17, wherein said three-dimensional representation of a dog is displayed when said button is not pressed.

19. A dog-faced watch system, the dog-faced watch system comprising:
a collar including;
a watch having;
a face;
a time display; and
a powerer;
a fastener; and
a leash loop;
wherein said collar is configured to be removeably secured to a neck of a canine said fastener;
wherein said fastener comprises a buckle-fastener;
wherein said buckle-fastener includes a male-portion and a female-portion configured to mate and secure said collar in a circular configuration;
wherein said watch is fastened to said collar via sewing means;
wherein said watch is integral to said collar;
wherein said face of said watch displays a three-dimensional representation of a dog;
wherein said three-dimensional representation is a functional image of a dog face;
wherein said dog face is a selected breed of said dog;
wherein said powerer provides power to said watch;
wherein said powerer is a battery;
wherein said watch comprises an illuminator;
wherein said illuminator is in communication with and powered via said powerer;
wherein said leash loop is configured to receive and secure a leash therein;
wherein said watch provides time identification as desired; and
wherein said collar is flexible and configured to encircle said neck of said canine.
